(19) United States
(12) Patent Application Publication
(10) Pub. No.: US 2012/0189995 A1
(43) Pub. Date: Jul. 26, 2012

(54) Dream Little Dreamer (DLD) Systems and Methods

(76) Inventor: Alisha M'Jestie Brooks, Virginia Beach, VA (US)

(21) Appl. No.: 13/011,896

(22) Filed: Jan. 22, 2011

(51) Int. Cl. G09B 19/00

(52) U.S. Cl. 434/236

(57) ABSTRACT

The present invention referred to as “Dream Little Dreamer” (DLD) provides an online social and educational environment focusing on positive human characteristics that influence children and on building self confidence. Dream Little Dreamer provides age appropriate learning materials geared towards preschool children to young adults (also referred to herein as “children”). Children are rewarded for completion and accuracy of educational and/or social activities with points that may be used to accomplish goals of building a dream world. Additional embodiments include online and live talent contests that include opportunities to learn online from other children and professional.

### COPENDING APPLICATION

This application claims priority benefit of U.S. Provisional Application Ser. No. 61/336,480, titled “Dream Little Dreamer,” filed Jan. 22, 2010, having the same inventor of the instant patent application and which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### DESCRIPTION

The Internet, where millions of computers interconnect and exchange data all over the world, is the ultimate resource for information and entertainment. As the Internet continues to evolve, it has both positive and negative effects on people, especially children.

The present invention referred to as “Dream Little Dreamer” (DLD) provides an online social and educational environment focusing on positive human characteristics that influence children and on building self confidence. Dream Little Dreamer provides age appropriate learning materials geared towards preschool children to young adults (also referred to herein as “children”). Children are rewarded for completion and accuracy of educational and/or social activities.

Further exemplary embodiments provide a virtual world that encourages each member to he creative, innovative and expressive while also unleashing a child's inner talent and dreams. Members can build their own personal character, upload and display their talents and accomplishments while working toward talent-oriented goals and/or educations goals. These embodiments disclose a virtual portrayal of each member both for the fun of creating a virtual character as well as the protection of a minor's identity. In some of the embodiments, the member receives positive reinforcement in the form of certificates, stars, virtual money, trophies, medals, ribbons, patches, stickers, or other form of reward for their accomplishments. The site includes parental guidance and involvement as parents work closely with their children to develop a child's own personal virtual world and to define parameters that enable a child to network live with others on the World Wide Web for education, social interaction, entertainment, work, and other purposes. As one of ordinary skill in the art recognizes, a member may opt to not create a virtual character to represent himself or herself and may opt to remain anonymous or to identify oneself, such as with a photograph that is profiled to other members and users.

Dream Little Dreamer features a unique virtual talent show or performing arts studio that allows the member to upload videos, recordings, music clips, pictures, documents or other electronic medium that can be uploaded to the site for portraying their talents. The member is rewarded for the submission regardless of the talent. Dream Little Dreamer holds talent competitions where parents can invite other friends, family members, or other acquaintances to securely log in, view and interactively vote online. The talent competitions may be live, pre-recorded or a combination of both.

The incessant virtual rewards are stored in a virtual room. This room is unique to each member as it can be interactively decorated by the member to reflect the member's personal preferences.

According to some of the embodiments, the web site acts as a preparation platform. Multimedia recordings of teachers teaching a particular subject are posted—instruction could he one lesson or a series of lessons. After a student view, listen, or interact with multimedia recording, the student is tested, the student's answer is reviewed, and if the answer is incorrect, then the correct answer is reviewed allowing the student to receive feedback on his/her level of competence. Each child is rewarded for the completion of the project.

Other embodiments of this invention describe a computer program product. A computer-readable medium stores a Dream Little Dreamer Module. The Dream Little Dreamer Module prompts a user (also referred to as a “student” or a “member”) to select activities, performing arts productions, talent shows, and accomplishments (e.g., doing well on a report card, making a tackle at a football game, doing well at a dance recital, having a surgery, having a tooth repaired, helping others, and others), if appropriate, to produce, perform or upload the talent, to compete, to receive rewards and Bravery Certificates, to maintain rewards and Bravery Certificates in a trophy room, to use achievement points to purchase virtual goods and services, and/or other activities to set up a virtual reality. This computer software is easy to use. Further, some of the embodiments include additional presentation capabilities so that a parent can access detailed information associated with his/her child's use, to analyze collective use, and/or historical information about a user's online experiences, preferences, achievements, etc.

### DESCRIPTION OF THE DRAWINGS

The possible embodiments, objects, uses, advantages, and novel features are more clearly understood by reference to the following description taken in conjunction with the with the accompanying figures herein:

FIG. 1 illustrates an overview of the Dream Little Dreamer users in accordance with sonic exemplary embodiments of the present invention;

FIG. 2 illustrates a diagram of a Dream Little Dreamer system in accordance with some exemplary embodiments of the present invention;

FIG. 3 illustrates a block diagram of a Dream Little Dreamer application operating on a communications device in accordance with some exemplary embodiments of the present invention;

FIG. 4 illustrates another Dream Little Dreamer system in accordance with some exemplary embodiments of the present invention; and

FIG. 5 illustrates an exemplary block diagram of member profile information and/or related interfaces or applications in accordance with some exemplary embodiments of the present invention.

### DESCRIPTION

Dream Little Dreamers systems and methods may be web-based or e-business application as well as a live social networking and entertainment application that contracts with customers (i.e., parents, guardians, grandparents or relatives, teachers, minors (to the extent possible for entering a contract as a minor individual) and others) for providing an character building opportunity to a young individual (child) who may obtain feedback from others, compete in online and/or online competitions, and earn rewards for building an online dream world.

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams, schematics, and the like represent conceptual views of illustrative circuitry embodying this invention. Similarly, it will be appreciated that any flow charts, flow diagrams, and the like represent various processes which may be substantially represented in computer readable medium and so executed by a computer or processor, whether or not such computer or processor is explicitly shown.

The functions of the various elements shown in the figures, including functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, sonic of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those skilled in the art further understand that the exemplary hardware, software, processes, methods, and/or operating systems described herein are for illustrative purposes and, thus, are not intended to be limited to any particular named manufacturer.

The term “present invention” is used herein to describe all of the attributes and possible incarnations of the invention, as well as any equivalent systems or forms of the invention. The embodiments of the present invention will now be described in greater detail, with some reference to the accompanying figures. This invention may, however, be construed in many different forms and should not be considered limited to the specific embodiments described herein. The description of these embodiments are provided in order to give a thorough and complete disclosure and arc intended to convey the full scope of the invention to those with relevant knowledge of the field. All statements within this document that describe the embodiments of the present invention are intended to encompass both structural and functional equivalents thereof. Such equivalents are intended to include both current equivalents and any equivalents that may be developed in the future, regardless of structure, that provide the same function.

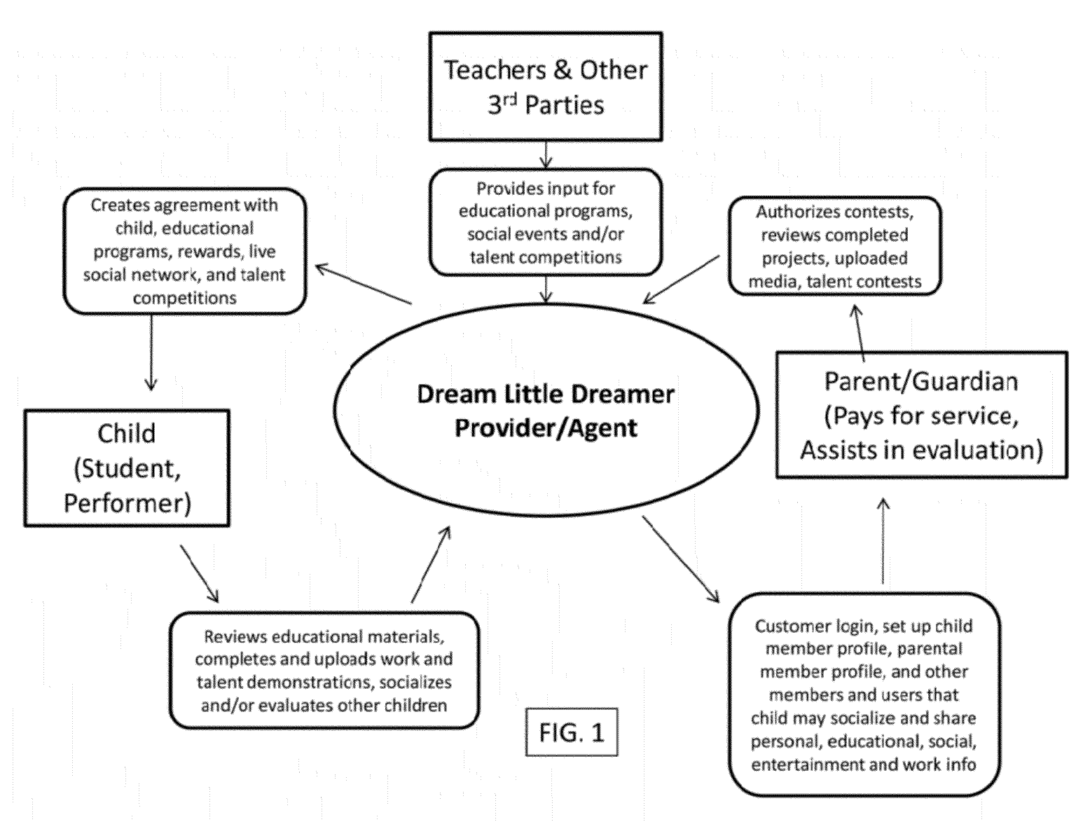

FIG. 1 illustrates an exemplary overview of a Dream Little Dreamer embodiment. Dream Little Dreamer is an online social and/or educational environment focusing on positive human characteristics that influence children and on building self confidence. Dream Little Dreamer provides age appropriate learning materials geared towards preschool children to young adults. Children are rewarded for completion and accuracy of educational and/or social activities.

According to some of the embodiments, a member enters a virtual world that encourages creativity, innovation and expression to inspire learning and goal-setting while also helping a child to work towards achieving a dream. In exemplary embodiments, members can build their own personal character, upload and display their talents and accomplishments while working toward talent-oriented goals and/or educations goals. These embodiments disclose a virtual portrayal of each member both for the fun of creating a virtual character as well as the protection of a minor's identity. In some of the embodiments, the member receives positive reinforcement in the form of certificates, stars, virtual money, trophies, medals, ribbons, patches, stickers or other form of reward for their accomplishments. The site includes parental guidance and involvement as parents work closely with their children to develop a child's own personal virtual world and to define parameters that enable a child to network live with others on the World Wide Web for education, social interaction, entertainment, work, and other purposes. As one of ordinary skill in the art recognizes, a member may opt to not create a virtual character to represent himself or herself and may opt to remain anonymous or to identify oneself, such as with a photograph that is profiled to other members and users.

Dream Little Dreamer features a unique virtual talent show or performing arts studio that allows the member to upload videos, recordings, music clips, pictures, documents or other electronic medium that can be uploaded to the site for portraying their talents. The member is rewarded for the submission regardless of the talent. Dream Little Dreamer holds talent competitions where parents can invite other friends, family members, or other acquaintances to securely log in, view and interactively vote online. The talent competitions may be live, pre-recorded or a combination of both.

The rewards may stored in a virtual room. This room is unique to each member as it can be interactively created and decorated by the member to reflect the member's personal preferences. For example, a member may have earned rewards that may be use to purchase a home, furniture, appliances, bicycles, sporting equipment, clothing, food, pets, vehicles, travel, personal items, education (e.g., private school, private tutoring, public school, etc.), and many other items that may be acquired new or used from other members (e.g., members may barter and swap out assets as well as incur liabilities that are accounted for in the rewards system).

According to some of the embodiments, the web site acts as a preparation platform. Multimedia recordings of teachers teaching a particular subject are posted—instruction could he one lesson or a series of lessons. Alternatively, tutoring sessions may he live and provide a one-on-one learning experience. After a student views, listens, or interacts with a multimedia recording or a live session, the student is tested, the student's answer is reviewed, and if the answer is incorrect, then the correct answer is reviewed allowing the student to receive feedback on his/her level of competence. Each child is rewarded for the completion of a project.

In accordance with FIG. 1, the Dream Little Dreamer “agent” allows a parent, guardian or other responsible third party to set up an account for the responsible party and a corresponding account for one or more children. The responsible party may associate other members or users that the child can interact. Alternatively, the responsible party may elect to receive a request or notification via email, telephone or other communications method when a member or user wants to contact the child (e.g., to set up a social network of young adults with common likes and dislikes). The child is then able to share messages and other content with others in his/her network. The responsible party pays for the service and may assist in evaluation of educational exercises, in establishing and reviewing goals, and in evaluation of other opportunities, such as rewards for completing a project, a review or rating of uploaded content for a talent contest, and other content that is associated with the child. For example, the responsible party may provide authorization to enter a contest.

The child is able to login and supplement any profile created by the responsible party (to the extent authorized by the responsible party) and select, access, and participate in educational, social, and entertainments competitions that are used to generate rewards or recognize participation. For example, the child may review and complete educational materials, upload talent demonstrations, set up goals or task lists, socialize with others, and/or evaluate or mentor other children.

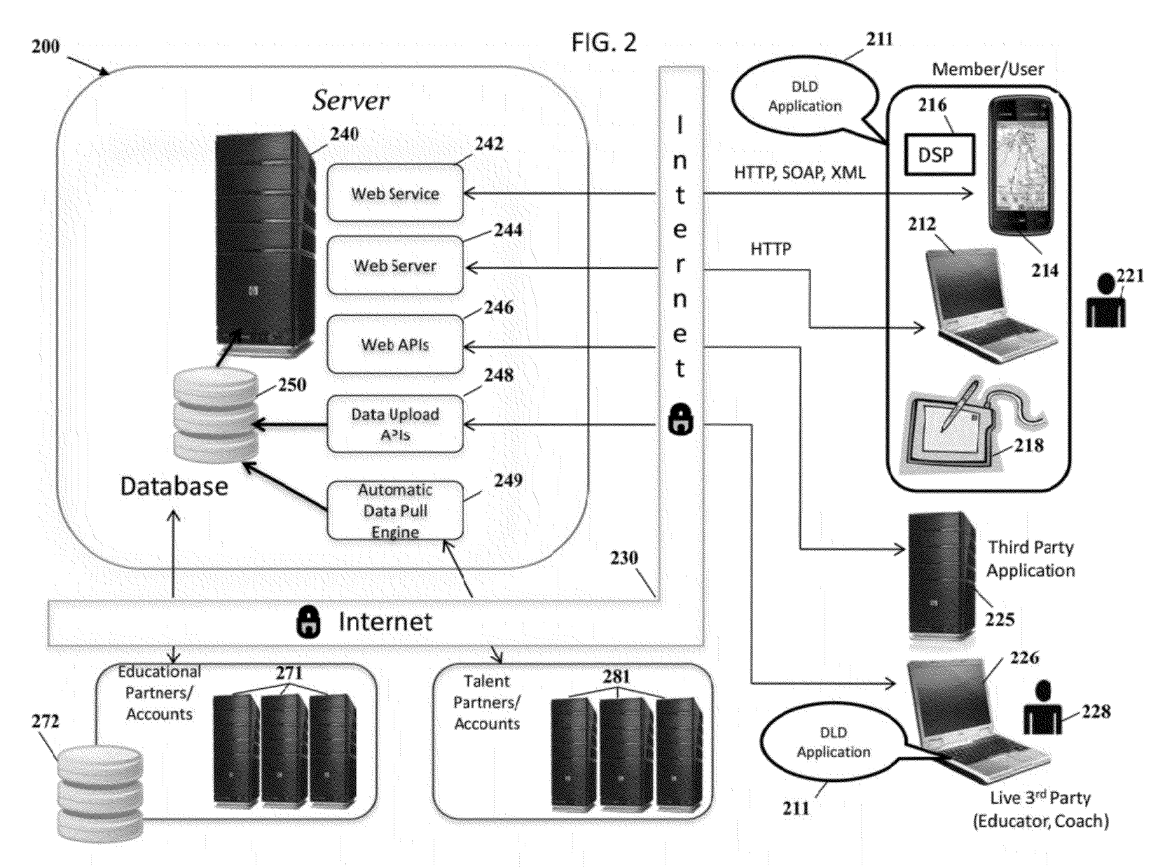

FIG. 2 illustrates another exemplary operating system 200 in accordance with some embodiments of the present invention. The system includes one or more mobile devices in secure communications (wired or wireless) with a volunteer (Dream Little Dreamer) website or some other networked dataserver 240 having a database 250 or collection of volunteer and non-profit records and a Dream Little Dreamer Application 211. The mobile devices are shown as a handheld tablet 218, a laptop computer 212, a cellular phone having integrated GPS and MP4 functionality 214, and any device with a digital signal processor 216. The devices and system components communicate using a web service 242, a web server 244, web-based APIs 246, data upload APIs 248, and/or others.

The mobile device is configured to communicate with the Dream Little Dreamer website using the WWW. The user may communicate with the Dream Little Dreamer website via another device and transfer tiles to the mobile device.

The mobile device or some other computing device may communicate with the website via the World Wide Web (WWW), Internet 230 or Intranet. The communication medium may he compatible with WiFi communications, IEEE 802.11 communications, 2 G, 2.5 G, 3G, 4G, XDSL, DSL, etc. Alternatively, the mobile device may communicate with the Dream Little Dreamer Application 211 via the Public Switch Telephone Network (PSTN) or via a satellite communications network.

The system is configured to operate with wired or wireless devices. The devices may include a cellular phone, a terminal, personal computer (PC), a wirelessly-equipped personal digital assistant (PDA), a wireless communications device, a laptop computer. The wireless communications may be a Code Division Multiple Access (CDMA) system, a Global System for Mobile Communications (GSM) system, satellite communications, cellular communication, mobile communications, or some other system.

The Dream Little Dreamer website and other websites comprise a web-based platform configured to execute a set of programs to interface with the devices, computers, and/or through the WWW. The web-based platform includes one or more processors, computers, servers to execute the set of programs for carrying out access to the website, set up and store user information, or operations to perform a variety of services to the non-profits and/or to the volunteers.

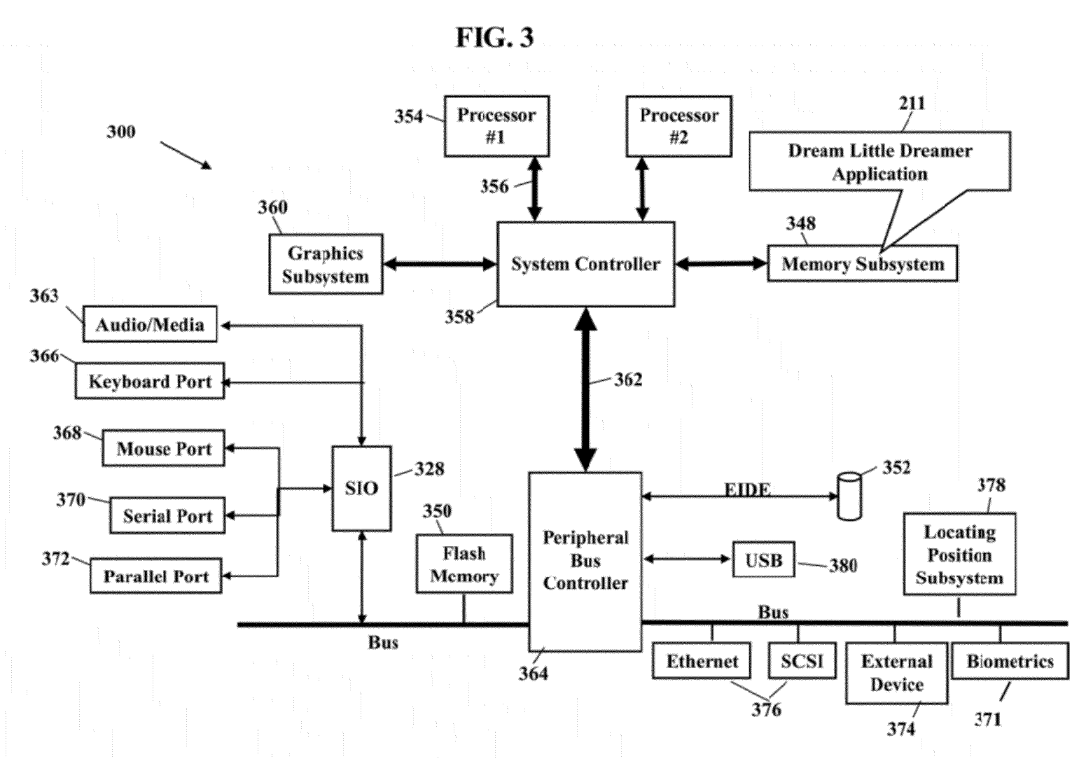

FIG. 3 is a block diagram showing the Dream Little Dreamer Application 211 residing in a communications system 300 and/or smart phone system. The Dream Little Dreamer Application 211 operates within a system memory device. The Dream Little Dreamer Application 211, for example, is shown residing in a memory subsystem 348. The Dream Little Dreamer Application 211, however, could also reside in flash memory 350 or peripheral storage device 352. The computer system also has one or more central processors 354 executing an operating system. The operating system, as is well known, has a set of instructions that control the internal functions of the computer system. A system bus 356 communicates signals, such as data signals, control signals, and address signals, between the central processor and a system controller 358 (typically called a “Northbridge”). The system controller provides a bridging function between the one or more central processors, a graphics subsystem 360, the memory subsystem, and a PCI (Peripheral Controller Interface) bus 362. The PCI bus is controlled by a Peripheral Bus Controller 364. The Peripheral Bus Controller (typically called a “Southbridge”) is an integrated circuit that serves as an input/output hub for various peripheral ports. These peripheral ports could include, for example, a keyboard port 366, a mouse port 368, a serial port 170 and/or a parallel port 372 for a video display unit, one or more external device ports 374 (e.g., biometrics subsystem 371 for verifying identifying information of a user), and networking ports 376 (such as SCSI or Ethernet). The Peripheral Bus Controller could also include an audio subsystem 363.

The system memory device (shown as memory subsystem, flash memory, or peripheral storage device) contains the Dream Little Dreamer Application 211 program. The Dream Little Dreamer Application 211 program cooperates with the operating system and with a video display unit (via the serial port and/or the parallel port) to provide a Graphical Customer Interface (GUI) and/or an audio interfaces via the audio/media subsystem 363. The Graphical Customer Interface provides a convenient visual and/or audible interface with the customer or user of the device 300. As is apparent to those skilled in the art, the selection and arrangement of data may be programmed over a variety of alternate mediums, such as, for example, a voice-activated menu prompt, an interactive session with an telecommunications network administrator, and the like.

Graphical user interfaces are use to display virtual experiences to the member. According to exemplary embodiments, the Dream Little Dreamer website may include a Showcase feature or function entitled. This function allows individuals or non-profits, to select information that can be displayed on a Showcase page or multiple pages. The Showcase page can be a profile page, classified ad, or a simplified resume which is public and accessible through search engines. The Showcase feature allow for the site's content and functionality to be dynamic.

The DLD system is meant to be accessed using wireless and/or non-wireless devices. The user selects navigational tabs associated with one or more DLD graphical user interfaces (GUIs) to access links, information or services for an (financial) agent, customer, or an employee, to get educated, get employed, etc. through various graphical user interfaces (GUIs).

The website is configured to operate in accordance with a website platform having at least one server, security protocols and databases. The at least one server includes at least one processor and one or more DLD applications. The DLD applications include, without limitation, applications and programs to perform, training, contest registration, agent registration or submission, employee setup, website navigation, tile a complaint, enter time in a time card, and other functions described herein, such as payroll and investment tracking. Thus, the applications may include a home module, an events module, an education application, a social networking feature that may be integrated with a member's online bulletin hoard or other publicly viewable data, education, training, and coaching features, contest registration, press release features, and redemption of rewards features.

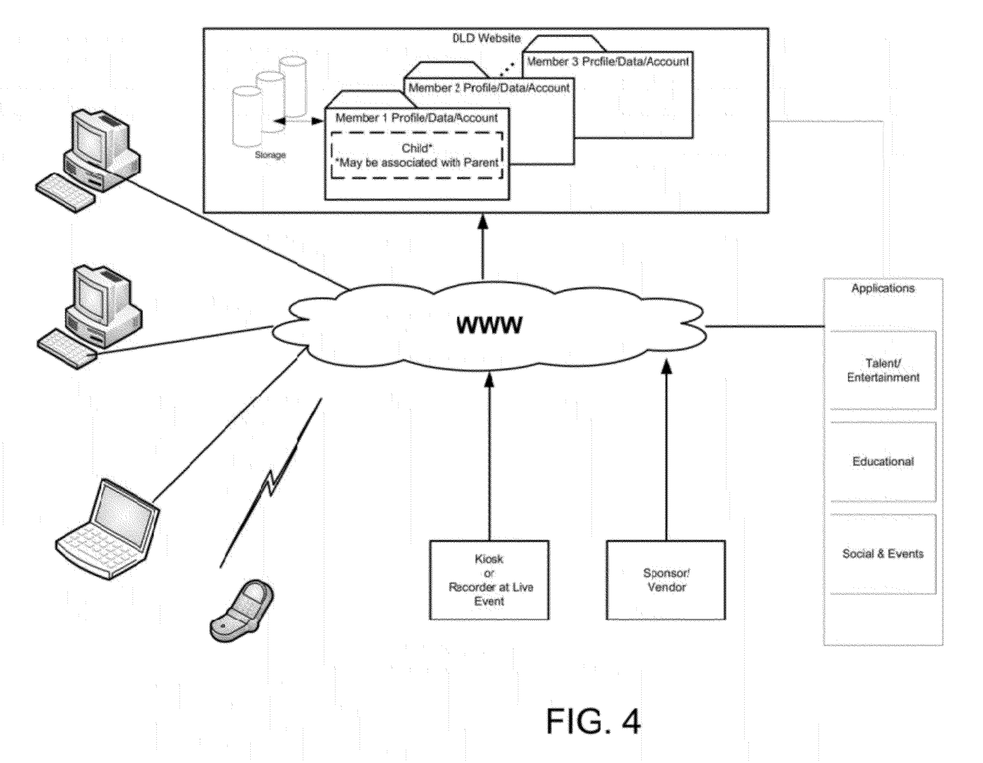

According to FIG. 4, one or more members, parents, and/or others may access the website using a personal computer (PC), Laptop, Notebook, etc. through the World Wide Web (WWW) or distributed content network during an online session. Additionally, the one or more users, parents, or others may access the website using a web-enabled user device such an IPhones, cellular phone, Blackberry phone, digital signal processor (DSP) device, etc.

The web-enabled user device may he any media or multi-media presentation device, such as a cellular phone, satellite phone, IPhones, a Voice over Internet Protocol (VOIP) phone, an interactive pager, a personal digital assistant (PDA), a television, and any communications device having a digital signal processor (DSP). The web-enabled user device may also include any computer, peripheral device, camera, modem, storage device, telephone, mobile phone, analog/digital recorder, CD/DVD player/recorder, audio equipment, receiver, tuner, and/or any other consumer multi-communications device.

The WWW or distributed content network may include in whole or part a television/cable network operating in the radio-frequency domain and/or the Internet Protocol (IP) domain, a communications network, such as the Internet, an intranet, a satellite network, a telecommunications network (e.g., Public Switched Telephone Network, Mobile Switching Telephone Office, and others), a local-area network (LAN), virtual private network (VPN), and/or a wide-area network (WAN). The WWW or distributed content network may include coaxial cables, copper wires, fiber optic lines, and/or hybrid-coaxial lines. The WWW or distributed content network may even include wireless portions utilizing any portion of the electromagnetic spectrum and any signaling standard (such as the I.E.E.E. 802 family of standards). The communications address of the head end (or alternate delivery source of the program) may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

The DLD system website is configured to be accessed using an Internet Browser, or other applications to communicate through a distributed content network as known in the art. The DLD system website would provide a plurality of graphical user interfaces (GUIs) to enable the user or others to interface with the website and perform various operations.

By using the services of and through the DLD website, the parent is in effect evaluating and rewarding the child for doing chores or for participating in talent contests. The nature of some of the tasks that a member may perform include completion of educational activities, talent-oriented activities, and others, such as completing basic household chores such as: cleaning bathrooms, cleaning windows, dusting, edging, feeding pets, folding laundry, gathering laundry, ironing, loading and unloading the dishwasher, making beds, mopping, mulching, pruning, raking, sweeping, taking a pet for a walk, taking out trash, tidying a room, vacuuming, washing laundry, watering grass/garden, watering indoor plants, and weeding the garden. Other duties may include filing, sweeping, babysitting, and more.

According to some of the embodiments, the Dream Little Dreamer website offers search engine indexing capabilities. Users of the Dream Little Dreamer website can create content that is shown publicly and is indexable by search engines. A publicly available member's webpage may appear on a Google search based on key words included in its user profile and indexed by the site. In other embodiments, the DLD system prevents content of member from being searchable by the public, and these embodiments may be preferred for young children.

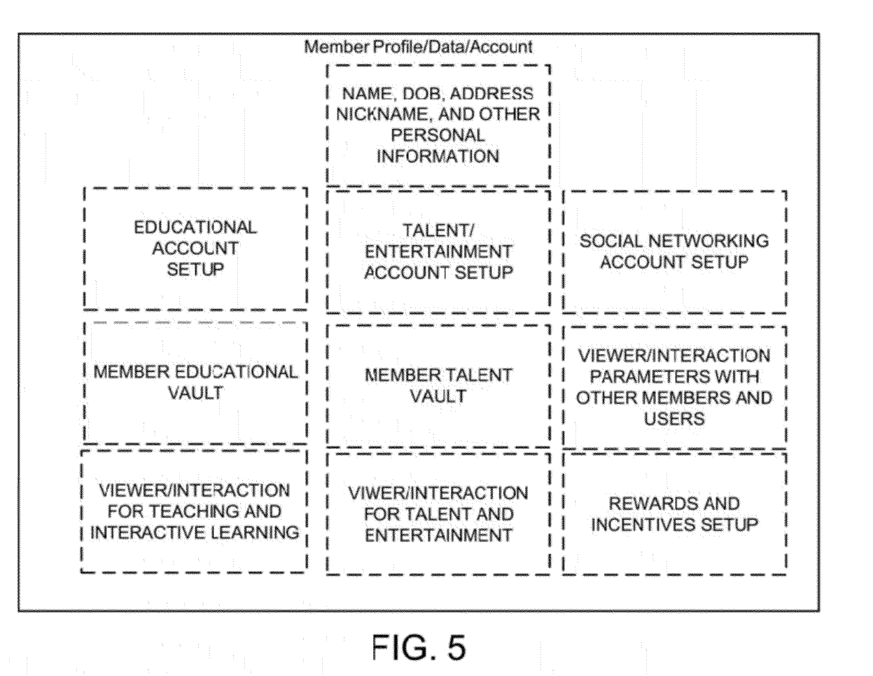

As best seen in FIG. 5, the member's profile includes a variety of content and interfaces with other featured programs including: setting up the account with fundamental information like name, date of birth, address, nickname, and other personal information; an educational account; data stored in an education vault; viewer and/or interaction for teaching and learning; talent/entertainment account set up; data stored in a talent vault; viewer and/or interaction for talent and entertainment; social networking and associated setup; viewer/interaction parameters with other members and outside users, and rewards and incentives. Data stored by any of the DLD “vaults” are stored in one or more databases for retrieval and download.

According to further embodiments, some of the highlighted features of the DLD system include:
Hosting events that promote live networking for its members;
Members have the opportunity to send audio, video, digital data and messaging to other authorized members and users. Some embodiments include a Fan Mail feature from other supportive and encouraging members.
Members can upgrade and/or change his/her virtual reality by redeeming rewards, bartering, winning contests, and/or inheriting rewards from members graduating out of DLD.
Members can join a Dream Little Dreamer Academy that sets educational and/or talent goals needed to graduate from the DLD Academy.
Members of DLD may be members of other clubs and networks, such as special workshops, presentations, contests, programs on other websites, and other programs.
Professionals from all walks of life may have multimedia recordings on the site for a child to access. Some multimedia recordings are targeted to a child; some are targeted to the responsible adult. Some provide training for the system, some educate, and some inspire goal setting and dreaming.
The DLD system may include similar programs through other mediums, such as television (IPTV), radio, community outreach events, print media, conventional schools, and other venues.
Members may tract metrics associated with his/her profile, such as goals accomplished, tasks performed, number of people they have inspires, awards, multimedia content, virtual world populated by acquired digital assets and other metrics.

While the present invention has been described with respect to various features, aspects, and embodiments, those skilled and unskilled in the art will recognize the invention is not so limited. Other variations, modifications, and alternative embodiments may he made without departing from the spirit and scope of the present invention.

What is claimed:

1. A method that includes all patentable subject matter set forth in the application and drawings.

2. A system that includes all patentable subject matter set forth in the application and drawings.
